(19) United States
(12) Patent Application Publication
(10) Pub. No.: US 2026/0110469 A1
(43) Pub. Date: Apr. 23, 2026

(54) MAGNETICALLY LATCHED REVERSING VALVE

(71) Applicant: Thomas J. Berwald, Grand Haven, MI (US)

(72) Inventor: Thomas J. Berwald, Grand Haven, MI (US)

(21) Appl. No.: 19/384,395

(22) Filed: Nov. 10, 2025

Related U.S. Application Data
(63) Continuation-in-part of application No. 18/795,778, filed on Aug. 6, 2024.

(51) Int. Cl. F25B 41/26; F16K 31/06; F16K 31/08; F25B 13/00

(52) U.S. Cl. CPC F25B 41/26; F16K 31/0613; F16K 31/082; F25B 13/00; F25B 2313/02741

(57) ABSTRACT

A magnetically latched reversing valve for a heat pump is provided. The reversing valve imparts an axial force on a flux ring, the flux ring being integrated into a sliding valve spool as a magnetically latched, two position reversing valve. In particular, the flux ring moves axially in response to an electromagnetic field generated by a solenoid coil, while a radially-magnetized permanent magnet provides the latching force to hold the flux ring in position. The flux ring is disk-shaped or ring-shaped, being movable in fixed relation with the valve spool. The reversing valve consumes electrical power only during the switching process, not while maintaining the valve position. This reduced power consumption leads to reduced heat generation, and the reversing valve maintains its position even in the event of a power failure, ensuring its reliability.

### CROSS-REFERENCE TO RELATED APPLICATIONS

This application is a continuation-in-part of U.S. patent application Ser. No. 18/795,778, filed Aug. 6, 2024, the disclosure of which is incorporated by reference in its entirety.

### FIELD OF THE INVENTION

The present invention relates to a magnetically latched reversing valve for a heat pump and for other applications.

### BACKGROUND OF THE INVENTION

Heat pumps are commonly used to transfer heat from a first location to a second location, with minimal losses of energy. Heat pumps can be used to provide space heating and/or space cooling, making them versatile and energy-efficient alternatives to traditional heating and cooling systems. Heat pumps generally include four main components: an evaporator, a compressor, a condenser, and an expansion valve. In a spacing heating mode, for example, refrigerant absorbs heat from outside air or the ground and evaporates into a gas in the evaporator coil. The gaseous refrigerant is then compressed by the compressor, increasing the temperature of the refrigerant. The hot, high-pressure refrigerant gas passes through the condenser coil, releasing heat as it condenses back into a liquid. The liquid refrigerant then passes through the expansion valve, dropping in pressure and temperature, and the cycle repeats.

Reversing valves are a critical component of most heat pump systems. Reversing valves allow the heat pump to reverse the flow of refrigerant, enabling the heat pump to switch between space heating and space cooling modes of operation. In a spacing cooling mode, the reversing valve directs the refrigerant to absorb heat from inside a building and release it outside. In the space heating mode, the reversing valve changes the direction of the refrigerant flow, directing the refrigerant to absorb heat from inside a building and release it outside.

Generally, reversing valves require a solenoid and a movable valve member. The solenoid is responsive to an electrical current and shifts the position of the movable valve member to change the direction of the refrigerant flow. Despite their availability, however, there remains a continued need for an improved reversing valve. In particular, there remains a continued need for an improved reversing valve with reduced power consumption, improved reliability, and enhanced efficiency for heat pumps and for other applications.

### SUMMARY OF THE INVENTION

A magnetically latched reversing valve for a heat pump is provided. The reversing valve imparts an axial force on a flux ring, the flux ring being integrated into a sliding valve spool as a magnetically latched, two position reversing valve. In particular, the flux ring moves axially in response to an electromagnetic field generated by a solenoid coil, while one or more permanent magnets provide the latching force to hold the flux ring in position. The flux ring is disk-shaped or ring-shaped, being movable in fixed relation with the valve spool. The reversing valve consumes electrical power only during the switching process, not while maintaining the valve position. This reduced power consumption leads to reduced heat generation, and the reversing valve maintains its position even in the event of a power failure, ensuring its reliability.

In one embodiment, the reversing valve includes a stator assembly having solenoid coil wrapped around a bobbin. The bobbin is fabricated from a non-ferrous material, such as a thermoplastic. The bobbin is generally U-shaped in cross-section. On either side of the bobbin, the reversing valve includes first and second ferromagnetic end-plates. The end-plates provide a flux path for magnetic field lines generated by the solenoid coil. The end-plates are formed from steel, optionally carbon steel with a high iron content.

The stator assembly also includes a radially-magnetized, cylindrically-shaped permanent magnet (or magnets) for latching the flux ring. The permanent magnet (or magnets) includes either of a radially inward magnetic orientation or a radially outward magnetic orientation. The stator assembly includes first and second magnetic flux concentration rings disposed about the radially-magnetized, cylindrically-shaped permanent magnet. The magnetic field lines extend radially across the thickness of the permanent magnet, creating a strong, uniform magnetic field for latching the flux ring. The flux ring extends around the valve spool and is spaced apart from the permanent magnet by an air gap, such that movement of the flux ring is not impeded by friction forces. The flux ring moves in response to the magnetic field generated by the solenoid coil, while the radially-magnetized permanent magnet (or magnets) provides the latching force for the flux ring. The stator assembly consumes power only during the switching process. This reduced power consumption leads to reduced heat generation, and the valve spool maintains its position even in the event of a power failure.

In another embodiment, the stator assembly includes an array of permanent magnets positioned in a Halbach configuration. A one-piece ring magnet or multiple arc-shaped segment magnets form a first ring magnet with a magnetic field axially directed to, and adjacent to, a center ring magnet. The center ring magnet is composed of a one-piece ring or multiple arc-shaped segments with a magnetic field oriented 90° toward the center line of the valve body or towards the flux ring on the reversible valve's movable spool. A second ring magnet is constructed of one piece or multiple arc-shaped segments with a magnetic field directed axially toward the center ring magnet. It is to be noted that all above-described magnets are in contact with each other.

The first ring magnet is bordered by the first end-plate and the center ring magnet. The second ring magnet is bordered by the center ring magnet and the second end-plate. The first and second ring magnets and the center ring magnet are permanent magnets, for example ferrite magnets, alnico magnets, samarium cobalt magnets, or neodymium iron boron magnets, as a few non-limiting examples. The end-plates define an annular flange with a plurality of mounting holes. The annular flange extends around the outer periphery of the bobbin, optionally for attachment to a mounting bracket. The flux ring is spaced apart from the permanent magnets by an air gap, such that movement of the flux ring is not impeded by friction forces.

In another embodiment, a heat pump is provided. The heat pump includes an outdoor heat exchanger, an indoor heat exchanger, a compressor, and a magnetically latched reversing valve. In a space cooling mode, the magnetically latched reversing valve couples the output of the compressor to the outdoor heat exchanger. The outdoor heat exchanger serves as a condenser while the indoor heat exchanger serves as an evaporator. In a space heating mode, the magnetically latched reversing valve couples the output of the compressor to the indoor heat exchanger. The indoor heat exchanger serves as a condenser, while the outdoor heat exchanger serves as an evaporator. The heat pump absorbs heat from the outdoor environment, compresses refrigerant to raise its temperature, and releases the heat indoors to warm the living space.

The reversing valve is therefore critical to changing the direction of the refrigerant flow within the heat pump, thereby enabling the heat pump to operate in each of a space heating mode and a space cooling mode. This flexibility means that the heat pump can operate optimally in different seasons, reducing energy consumption compared to separate heating and cooling systems. In addition, by combining heating and cooling functions into one system, facilitated by the reversing valve, space is saved. Because the reversing valve consumes power only during the switching process, the reduced power consumption leads to reduced heat generation, and the reversing valve maintains its position even in the event of a power failure.

These and other features of the invention will be more fully understood and appreciated by reference to the description of the embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is cross-sectional view of a magnetically latched reversing valve in a first latched position.

FIG. 2 is cross-sectional view of the magnetically latched reversing valve of FIG. 1 in a second latched position.

FIG. 3 is a cross-sectional view of the stator assembly for the magnetically latched reversing valve of FIG. 1.

FIG. 4 is a schematic diagram of a heat pump including the reversing valve of FIG. 4 in a space cooling mode.

FIG. 5 is a schematic diagram of a heat pump including the reversing valve of FIG. 4 in a space heating mode.

FIG. 6 is a cross-sectional view of a stator assembly for a magnetically latched reversing valve in accordance with a second embodiment.

FIG. 7 is a cross-sectional view of a stator assembly for a magnetically latched reversing valve in accordance with a third embodiment.

### DETAILED DESCRIPTION OF THE CURRENT EMBODIMENTS

The current embodiments include a magnetically latched reversing valve for a heat pump. The reversing valve includes a stator assembly for magnetically latching a sliding spool in one of two positions. The stator assembly includes a stator for imparting an axial force on a flux ring, the flux ring being integrated into the sliding spool as a magnetically latched, two position reversing valve. Each such aspect of the reversing valve is separately discussed below.

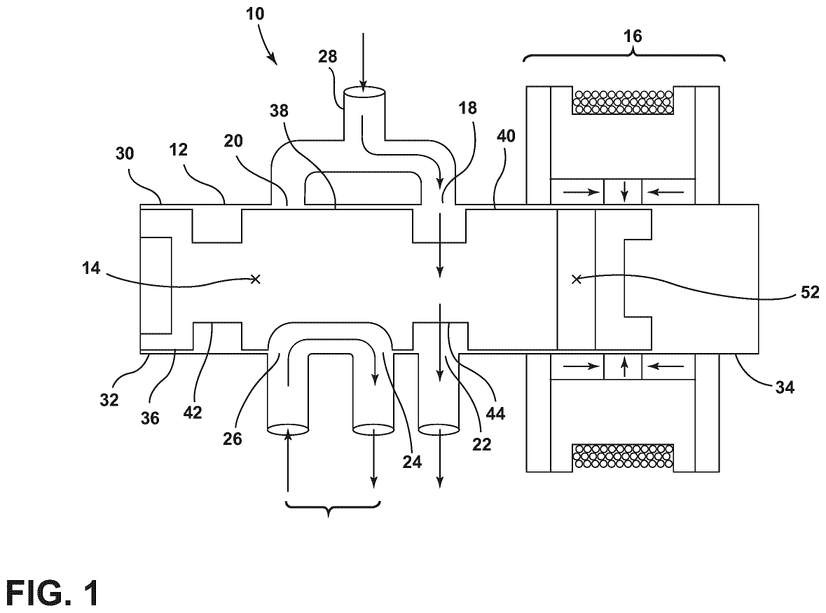

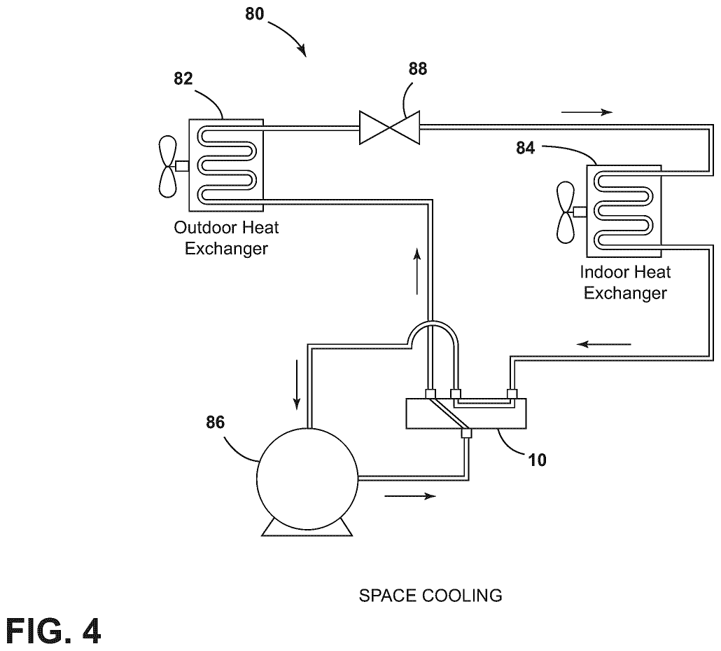

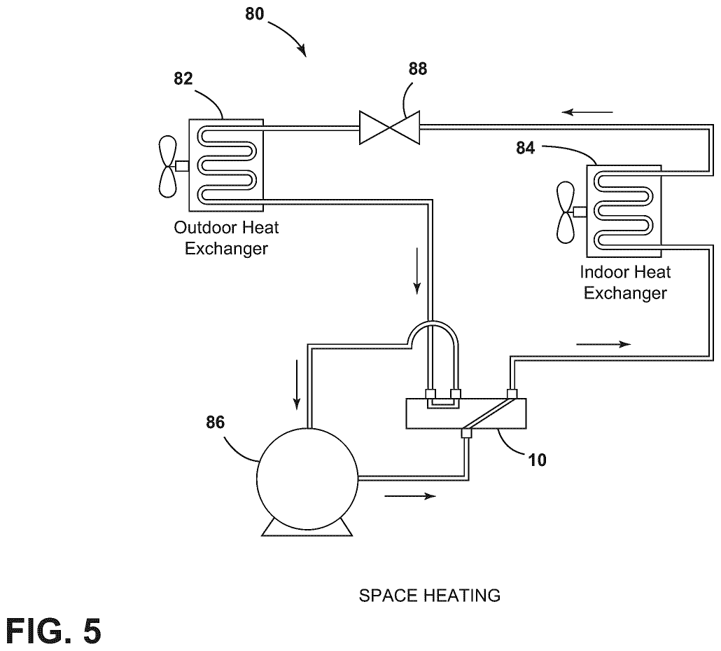

Referring first to FIG. 1, a reversing valve in accordance with one embodiment is illustrated and designated 10. The reversing valve 10 includes valve body 12, a valve spool 14, and a stator assembly 16. The valve body 12 houses the valve spool 14 therein and includes two input ports 18, 20 and three output ports 22, 24, 26. The input ports 18, 20 are coupled to a manifold 28 in fluid communication with a compressor. The output ports 22, 24, 26 are coupled to an outdoor coil or an indoor coil, discussed below in connection with FIGS. 4-5.

As also shown in FIG. 1, the valve body 12 includes a cylindrical sidewall 30 that defines a spool bore. The spool bore extends from a first end 32 of the valve body 12 to a second end 34 of the valve body 12 for linear movement of the valve spool 14 therein. The valve spool 14 is movable axially within the valve body 12 in a first direction (toward the first end 32 of the valve body 12) and in a second direction (toward the second end 34 of the valve body 12). The valve spool 14 includes multiple lands and multiple grooves for selectively connecting the input ports to the output ports. In particular, the valve spool 14 includes a first land 36, a second land 38, and a third land 40, with each land having an outer diameter approximately equal to the inner diameter of the valve body 12 for sealing off the input ports and the output ports. The valve spool 14 also includes a first annular groove 42 and a second annular groove 44. The first groove 42 is disposed between the first land 36 and the second land 38, and the second groove 44 is disposed between the second land 38 and the third land 40. The first and second grooves 42, 44 are recessed relative to each land 36, 38, 40, thereby allowing fluid to pass through the reversing valve 10.

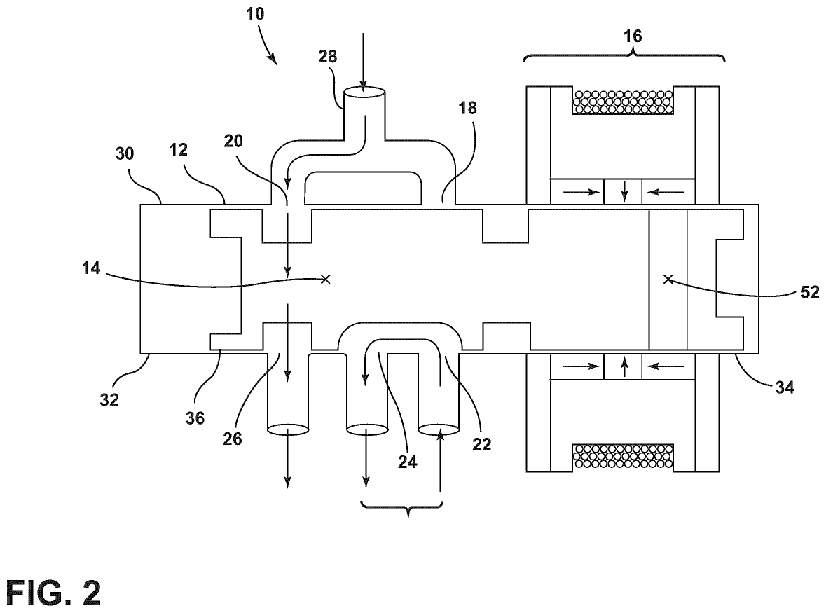

In the position shown in FIG. 1, for example, the valve spool 14 connects the first input port 18 with the first output port 22, while the second input port 20 remains closed and the second and third output ports 24, 26 are coupled together. In the position shown in FIG. 2, by contrast, the valve spool 14 connects a second input port 20 with the third output port 26, while the first input port 18 remains closed and the first and second output ports 22, 24 are coupled together. While a five port spool valve is illustrated, other embodiments can include a different number of ports. In addition, the reversing valve 10 can optionally include balancing springs on either side thereof to potentially reduce the force required to actuate the valve spool 14.

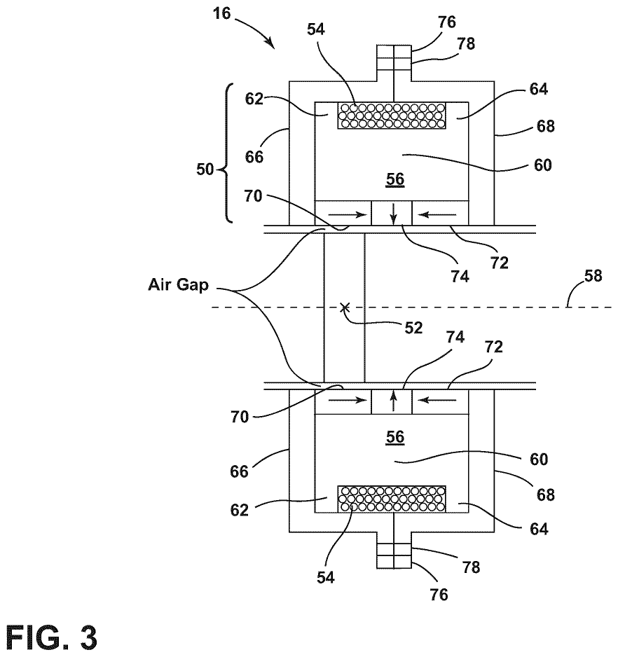

Referring now to FIG. 3, the stator assembly 16 is more specifically illustrated. The stator assembly 16 includes a stator 50 for imparting an electromagnetic force on a flux ring 52. In particular, the stator 50 includes an electromagnetic coil 54 wrapped around a bobbin 56. The bobbin 56 is fabricated from a non-ferrous material, such as a thermoplastic. While only a cross-section is shown, the bobbin 56 extends in a continuous loop defining a central axis 58. The bobbin 56 is generally U-shaped in cross-section, having a base 60 and first and second sides 62, 64. On either side of the bobbin 56, the stator assembly 16 includes first and second ferromagnetic end-plates 66, 68. The end-plates 66, 68 are ring-shaped and provide a flux path for magnetic field lines generated by the electromagnetic coil 54. The end-plates 66, 68 are formed from steel in the illustrated embodiment, optionally carbon steel with a high iron content.

The stator assembly 16 also includes a first plurality of magnets 70 and a second plurality of magnets 72 that are separated from each other by an axially oriented permanent ring magnet 74 with the magnetic field directed toward the spool's flux ring 52. The first plurality of magnets 70 have a first polarity and are disposed adjacent the inner diameter of the bobbin 56. The first plurality of magnets 70 are bordered by the first end-plate 66 and the ring magnetic 74. Each of the first plurality of magnets 70 extend through an arc, the total of which defines a circle having an outer diameter equal to the inner diameter of the bobbin 56. Similarly, the second plurality of magnets 72 have a second polarity, different from the first polarity. The second plurality of magnets 72 are bordered by the ring magnetic 74 and the second end-plate 68. Each of the second plurality of magnets 72 extend through an arc, the total of which defines a circle having an outer diameter equal to the inner diameter of the bobbin 56. The permanent magnets 70, 72, 74 are optionally ferrite magnets, alnico magnets, samarium cobalt magnets, or neodymium iron boron magnets, as a few non-limiting examples. Collectively, the end-plates 66, 68 define an annular flange 76 with a plurality of mounting holes 78. The annular flange 76 extends around the outer periphery of the bobbin 56, optionally for attachment to a mounting bracket. As also shown in FIG. 3, the flux ring 52 is spaced apart from the stator 50 by an air gap, such that movement of the flux ring 52 is not impeded by friction forces.

The ring magnet 74 has a radial polarity, such that the north and south poles are on the inner and outer cylindrical surfaces of the ring. The inner diameter of the ring magnet 74 is one pole (e.g., north), and the outer diameter is the opposite pole (e.g., south). By contrast, the first plurality of magnets 70 and the second plurality of magnets 72 have an axial polarity, such that the north and south poles are on the flat circular faces of the ring segments. One face is the north pole, and the opposite face is the south pole. In the embodiment shown in FIGS. 1-3, the arrows point toward the north pole of each respective permanent magnet. For example, the ring magnet 74 has a north pole on its inner cylindrical surface, the first plurality of magnets 70 have a north pole on the flat surface abutting the ring magnet 74, and the second plurality of magnets 72 have a north pole on the flat surface abutting the ring magnet 74. In other embodiments, however, the ring magnet 74 has a north pole on its outer cylindrical surface, the first plurality of magnets 70 have a north pole on the flat surface distal from the ring magnet 74, and the second plurality of magnets 72 have a north pole on the flat surface distal from the ring magnet 74.

Operation of the stator assembly 16 will now be described. As noted previously, the reversing valve is magnetically latched, meaning it uses magnetic fields to maintain the desired position of the valve spool 14 without continuous power application. When an electromagnetic pulse is applied to the solenoid coil 54, it generates a magnetic field that moves the ferromagnetic flux ring 52 axially, dependent upon the direction of the electromagnetic pulse, i.e., the current direction. After the pulse is removed, the magnetic field generated by the nearest plurality of permanent magnets 70, 72 maintains the flux ring 52 in its position without the need for continuous electrical power to the solenoid coil 54. A reverse electrical pulse is applied to move the flux ring 52 back to its original position, and consequently the valve spool 14. The permanent magnets 70, 72, 74 provide the latching force to hold the valve in the first position (leftward), shown in FIG. 1. Similarly, the permanent magnets 70, 72, 74 provide the latching force to hold the valve in the second position (right), shown in FIG. 2.

To reiterate, the flux ring 52 moves in response to the magnetic field generated by the solenoid coil 54, while the permanent magnets 70, 72 provide the latching force to hold the flux ring 52 in position. The flux ring 50 is disk-shaped or ring-shaped, being movable in fixed relation with the valve spool 14. Advantageously, the reversing valve 10 consumes power only during the switching process, not while maintaining the valve position. The reduced power consumption leads to reduced heat generation, and the reversing valve maintains its position even in the event of a power failure, ensuring reliability in critical operations.

Referring now to FIGS. 4-5, a heat pump including the improved reversing valve 10 is illustrated and generally designated 80. The heat pump 80 includes an outdoor heat exchanger 82, an indoor heat exchanger 84, a compressor 86, an expansion valve 88, and the improved reversing valve 10 of FIGS. 1-3. In a space cooling mode as shown in FIG. 4, the indoor heat exchanger 84 serves as an evaporator, and the outdoor heat exchanger 82 serves as a condenser. In particular, the reversing valve 10 couples the output of the compressor 86 to the outdoor heat exchanger 82. The condensed refrigerant is then directed to the indoor heat exchanger 84, where the condensed refrigerant is evaporated by heat exchange with the space to be cooled. Refrigerant returns to the compressor 86 at low pressure. In a space heating mode as shown in FIG. 5, the refrigerant absorbs heat from the outside and releases it indoors. In particular, the reversing valve 10 couples the output of the compressor 86 to the indoor heat exchanger 84. The indoor heat exchanger 84 serves as a condenser, and the outdoor heat exchanger 82 serves as an evaporator. The heat pump 80 thus absorbs heat from the outdoor environment, compresses refrigerant to raise its temperature, and releases the heat indoors to warm the living space.

The reversing valve 10 is therefore critical to changing the direction of the refrigerant flow within the heat pump 80, thereby enabling the heat pump to operate in each of a space heating and space cooling mode. This flexibility means that the heat pump 80 can operate optimally in different seasons, reducing energy consumption compared to separate heating and cooling systems. In addition, by combining heating and cooling functions into one system, facilitated by the reversing valve 10, spaced is saved. Because the reversing valve 10 consumes power only during the switching process, the reduced power consumption leads to reduced heat generation, and the reversing valve maintains its position even in the event of a power failure.

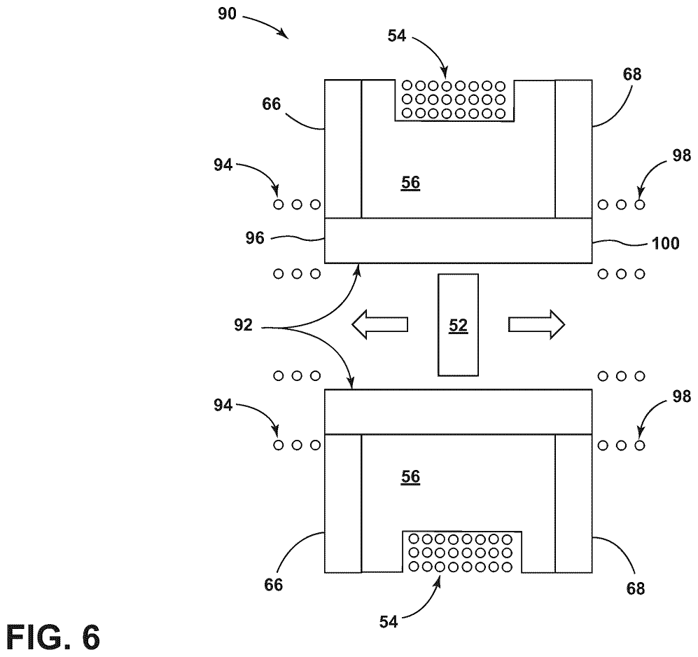

Referring now to FIG. 6, a stator assembly in accordance with a second embodiment is illustrated and generally designated 90. The stator assembly of FIG. 6 is similar in structure and in function to the stator assembly of FIG. 3, except that the permanent magnets 70, 72, 74 are replaced with a single isotropic ring magnet 92 for latching the ferromagnetic flux ring 52. In contrast to anisotropic magnets, which have a preferred direction of magnetization, isotropic magnets exhibit the same magnetic behavior in all directions, i.e., there is no preferred direction of magnetization. To provide a magnetic orientation to the isotropic ring magnet 92, the stator assembly 90 includes a first conductive winding 94 adjacent a first axial surface 96 of the isotropic ring magnet 92 and includes a second conductive winding 98 adjacent a second axial surface 100 of the isotropic ring magnet 92. The conductive windings 98, 100 are coupled to a suitable DC power supply. When pulsed with an electrical current in the desired direction, the conductive windings 96, 100 generate opposing magnetic fields that flow through the ferromagnetic flux ring 52 according to the right-hand rule (the direction of the magnetic field lines are determined by the direction of the electrical current). The magnetic field produced by the conductive windings 94, 98 aligns the magnetic domains of the isotropic ring magnet 92 in the direction of this field. The longer the current is applied to the conductive windings 94, 98 the more time the magnetic domains have to align. The isotropic ring magnet 92 retains its magnetism after the current has been terminated. The isotropic ring magnet 92 magnetically latches the flux ring 52 in the left position or the right position in the same manner as discussed above in connection with FIG. 3, replacing the permanent magnets 70, 72, 74 with a single magnet 92.

In sum, the flux ring 52 moves in response to the magnetic field generated by the solenoid coil 54, while the isotropic ring magnet 92 provides the latching force to hold the flux ring 52 in position. The isotropic ring magnet 92 is ring shaped, and the flux ring 50 is disk-shaped or ring-shaped. The reversing valve 10 consumes power only during the switching process. As with the above embodiment, this reduced power consumption leads to reduced heat generation, and the reversing valve maintains its position even in the event of a power failure.

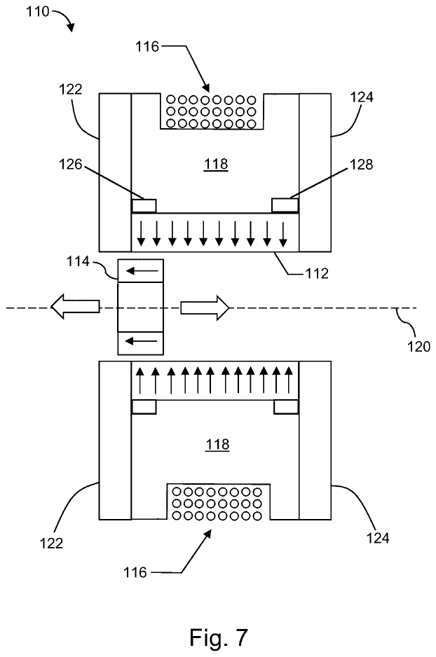

Referring now to FIG. 7, a stator assembly in accordance with a third embodiment is illustrated and generally designated 110. The stator assembly 110 of FIG. 7 is similar in structure and in function to the stator assembly of FIG. 3, except that the permanent magnets 70, 72, 74 of FIG. 3 are replaced with a radially-magnetized, cylindrically-shaped permanent magnet 112 for latching a ferromagnetic flux ring 114. The cylindrically-shaped permanent magnet 112 is magnetized radially, with either of a radially inward magnetic orientation (as shown in FIG. 7) or a radially outward magnetic orientation. The magnetic field lines extend radially across the thickness of the cylindrically-shaped magnet 112, creating a strong, uniform magnetic field within the bore of the magnet 112 for latching the ferromagnetic flux ring 114. The flux ring 114 extends around the valve spool (as shown in FIG. 1) and is spaced apart from the permanent magnet 112 by an air gap, such that movement of the flux ring 114 is not impeded by friction forces.

Similar to the first embodiment, the stator assembly 110 includes a solenoid coil 116 wrapped around a bobbin 118. The bobbin 118 is fabricated from a non-ferrous material, such as a thermoplastic. While only a cross-section is shown, the bobbin 118 extends in a continuous loop defining a central axis 120. The bobbin 118 is generally U-shaped in cross-section. On either side of the bobbin 118, the stator assembly 110 includes first and second ferromagnetic end-plates 122, 124. The end-plates 122, 124 are ring-shaped and provide a flux path for magnetic field lines generated by the solenoid coil 116. The end-plates 122, 124 are formed from steel in the illustrated embodiment, optionally carbon steel with a high iron content. While one cylindrical magnet 112 is shown in FIG. 7, other embodiments include a stacked array of radially-magnetized ring magnets, having the same magnetic field strength as the single cylindrical magnet 112.

As also shown in FIG. 7, the stator assembly 110 includes first and second magnetic flux concentration rings 126, 128. The magnetic flux concentration rings 126, 128 are ferromagnetic rings that are configured to channel and intensify magnetic field lines, thereby concentrating the magnetic flux. By guiding the magnetic field through a higher-permeability path, the magnetic flux concentration rings 126, 128 increase the magnetic coupling with the flux ring 114. Two such rings 126, 128 are shown in FIG. 7, being axially spaced apart from each other. The inner diameter of each such ring 126, 128 abuts the outer diameter of the cylindrically-shaped magnet 112, creating a strong, uniform magnetic field within the bore of the magnet 112 for latching the ferromagnetic flux ring 114. The rings 126, 128 are not strictly necessary however, and other embodiments can have still more magnetic flux concentration rings.

The stator assembly 110 is magnetically latched, meaning it uses magnetic fields to maintain the desired position of the flux ring 114. When an electrical current is applied to the solenoid coil 116, the solenoid coil 116 generates a magnetic field that moves the ferromagnetic flux ring 114 axially in a first direction (e.g., leftward), dependent upon the direction of the electrical current. After the current is removed, the magnetic field generated by the radially-oriented permanent magnet 112 maintains the flux ring 114 (and therefore the valve spool) in its position without the need for continuous electrical power to the solenoid coil 116. A reverse electrical current is applied to move the flux ring 114 in a second direction (e.g., rightward). The radially-magnetized permanent magnet 112 provides the latching force to hold the flux ring 114 in its new position without the need for continuous electrical power to the solenoid coil 116.

In sum, the flux ring 114 moves in response to the magnetic field generated by the solenoid coil 116, while the radially-magnetized permanent magnet 112 provides the latching force for the flux ring 114. The stator assembly 110 consumes power only during the switching process. As with the above embodiments, this reduced power consumption leads to reduced heat generation, and the valve spool maintains its position even in the event of a power failure.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A magnetically latched reversing valve, the reversing valve comprising:
a valve body including an input port for fluid communication with a compressor and a plurality of output ports for fluid communication with first and second heat exchangers;
a valve spool slidably disposed within the valve body for coupling the input port to selective ones of the plurality of output ports;
a flux ring coupled to the valve spool and moveable in fixed relation with the valve spool, the flux ring being formed of a ferromagnetic material; and
a stator assembly comprising:
a solenoid coil wound about a bobbin defining an inner diameter, the solenoid coil configured to allow an electrical current to pass therethrough,
a radially-magnetized permanent magnet adjacent the inner diameter of the bobbin, the radially-magnetized permanent magnet being centered in relation to the bobbin,
wherein the flux ring is movable between a first position and a second position in response to a direction of an electrical current in the solenoid coil, and wherein the flux ring is latchable in the first position by the radially-magnetized permanent magnet and is latchable in the second position by the radially-magnetized permanent magnet.

2. The reversing valve of claim 1, wherein the radially-magnetized permanent magnet comprises at least one magnet.

3. The reversing valve of claim 2, wherein the at least one magnet comprises a cylindrically-shaped magnet.

4. The reversing valve of claim 2, wherein the at least one magnet comprises an array of ring magnets.

5. The reversing valve of claim 1, further including a first ferromagnetic end plate adjacent a first axial surface of the bobbin and a second ferromagnetic end plate adjacent a second axial surface of the bobbin, wherein the first and second ferromagnetic end plates are ring-shaped and provide a flux path for magnetic field lines generated by the solenoid coil.

6. The reversing valve of claim 1, wherein the flux ring defines an air gap with respect to the radially-magnetized permanent magnet.

7. The reversing valve of claim 1, wherein the flux ring is formed from a ferromagnetic material and is physically coupled to the valve spool.

8. A heat pump comprising:
a compressor having an input port and an output port;
an outdoor heat exchanger;
an indoor heat exchanger; and
the reversing valve of claim 1.

9. The heat pump of claim 8, wherein, in a space cooling mode, the reversing valve couples the output port of the compressor to the outdoor heat exchanger and couples the input port of the compressor to the indoor heat exchanger.

10. The heat pump of claim 8 wherein, in a space heating mode, the reversing valve couples the output port of the compressor to the indoor heat exchanger and couples the input port of the compressor to the outdoor heat exchanger.

11. A stator assembly for a reversing valve having a flux ring coupled to a valve spool, the stator assembly comprising:
a solenoid coil wound about a bobbin defining an inner diameter, the solenoid coil configured to allow an electrical current to pass therethrough;
a radially-magnetized permanent magnet adjacent the inner diameter of the bobbin, the radially-magnetized permanent magnet being fixed in relation to the bobbin;
wherein the flux ring is movable between a first position and a second position in response to a direction of the electrical current in the solenoid coil, and wherein the flux ring is latchable in the first position by the radially-magnetized permanent magnet and is latchable in the second position by the radially-magnetized permanent magnet.

12. The stator assembly of claim 11, wherein the radially-magnetized permanent magnet comprises at least one magnet.

13. The stator assembly of claim 12, wherein the at least one magnet comprises a cylindrically-shaped magnet.

14. The stator assembly of claim 12, wherein the at least one magnet comprises an array of ring magnets.

15. The stator assembly of claim 11, further including a first ferromagnetic end plate adjacent a first axial surface of the bobbin and a second ferromagnetic end plate adjacent a second axial surface of the bobbin, wherein the first and second ferromagnetic end plates are ring-shaped and provide a flux path for magnetic flux field lines generated by the solenoid coil.

16. The stator assembly of claim 11, wherein the flux ring defines an air gap with respect to the radially-magnetized permanent magnet.

17. The stator assembly of claim 11, wherein the flux ring is latchable in each of the first and second positions without an electrical current in the solenoid coil.

18. The stator assembly of claim 11, wherein the flux ring is formed from a ferromagnetic material and is physically coupled to the valve spool.

19. The stator assembly of claim 11, further comprising first and second magnetic flux concentration rings disposed about the radially-magnetized permanent magnet.

20. The stator assembly of claim 19, wherein the first and second magnetic flux concentration rings are axially spaced apart from each other and abut respective ferromagnetic end plates.
